(19) United States
(12) Patent Application Publication
(10) Pub. No.: US 2024/0211297 A1
(43) Pub. Date: Jun. 27, 2024

(54) METHOD FOR A PRIMARY VIRTUAL MACHINE TO SCHEDULE A TASK OF SIBLING VIRTUAL MACHINES

(71) Applicant: Intel Corporation, Santa Clara, CA (US)

(72) Inventors: Zhao LIU, Shanghai (CN); Zhenyu WANG, Shanghai, CA (US)

(21) Appl. No.: 18/395,766

(22) Filed: Dec. 26, 2023

(30) Foreign Application Priority Data
Sep. 26, 2023 (WO) PCT/CN2023/121304

(51) Int. Cl. G06F 9/455

(52) U.S. Cl. CPC G06F 9/45558; G06F 2009/45562

(57) ABSTRACT

A method for a primary virtual machine (VM) to schedule a sibling VM task executed by a hypervisor. Upon request of the sibling VM, the hypervisor creates a sibling task which includes a hypervisor ID. The hypervisor ID is then communicated to the primary VM. Subsequently, the primary VM creates a broker task, identified by its broker ID, and based on the received hypervisor ID for the sibling VM task. The primary VM then communicates to the hypervisor a mapping of the broker ID to the corresponding hypervisor ID. Finally, the primary VM executes the broker task when instructed by a scheduler of the primary VM. The broker task then triggers the hypervisor to run the corresponding sibling task based on the mapping.

### CROSS-REFERENCE TO RELATED APPLICATION

This application claims priority to Chinese PCT Application PCT/CN2023/121304, filed on Sep. 26, 2023. The content of this earlier filed application is incorporated by reference herein in its entirety.

### BACKGROUND

In certain computing environments, such as thin-client virtualization, a primary virtual machine (VM) is responsible for managing the majority of system resources. This may include managing certain central processing unit (CPU) resources, memory allocation, power management, and peripheral device access. A primary VM may also be responsible for the creation or destruction of sibling or application VMs.

However, due to the isolated nature of the virtualized environment, a primary VM has no direct control over the scheduling of sibling VMs. So sibling VMs compete for CPU resources amongst themselves as well as with the primary VM. Although the creation and destruction of sibling VMs can often be controlled by the primary VM, the CPU resources consumed by sibling VMs while running are out of the primary VM's control. Therefore, an improved method for a primary VM to schedule sibling VMs is desired.

### BRIEF DESCRIPTION OF THE FIGURES

Some examples of apparatuses and/or methods will be described in the following by way of example only, and with reference to the accompanying figures, in which

FIG. 1 shows an example of para-virtualized scheduling architecture at a high level;

FIGS. 2A to 2C show a block diagram of methods for the para-virtualized scheduling;

FIG. 3 shows an overview of a kernel-based virtual machine module (KVM) architecture;

FIG. 4 shows the CPU resource competition problem caused by double scheduling;

FIG. 5 shows an example of regular primary virtual machine (VM) architecture;

FIG. 6 shows components of para-virtualized scheduling in accordance with one example;

FIG. 7 shows a main process of a virtual register mechanism in accordance with one example;

FIG. 8 shows an example structure of VIRT_PARA_SCHED_TASK in accordance with one example;

FIG. 9 shows an example structure of VIRT_PARA_SCHED_MAP;

FIG. 10 shows an example structure of VIRT_PARA_SCHED_CTRL;

FIG. 11 shows a mapping between a broker task and a sibling VM's vCPU thread in accordance with one example;

FIG. 12 shows an example of eBPF hooks of para-virtualized scheduling;

FIG. 13 shows an example registration of worker and server;

FIG. 14 shows waking up the worker and sleeping the server in accordance with one example;

FIG. 15 shows waking up the server and sleep the worker in accordance with one example;

FIG. 16 is a block diagram of an electronic apparatus incorporating at least one electronic assembly and/or method described herein;

FIG. 17 illustrates a computing device in accordance with one implementation of the disclosed embodiments; and

FIG. 18 shows an example of a higher-level device application for the disclosed embodiments.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures, same or similar reference numerals refer to same or similar elements and/or features, which may be identical or implemented in a modified form while providing the same or a similar function. The thickness of lines, layers, and/or areas in the figures may also be exaggerated for clarification.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

When two elements A and B are combined using an “or,” this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a,” “an,” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include,” “including,” “comprise,” and/or “comprising,” when used, describe the presence of the specified features, integers, steps, operations, processes, elements, components, and/or a group thereof, but do not exclude the presence or addition of one or more other features, integers, steps, operations, processes, elements, components and/or a group thereof.

Unless otherwise defined, all terms (including technical and scientific terms) are used herein in their ordinary meaning of the art to which the examples belong.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating,” “executing,” or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

It should be noted that the example schemes disclosed herein are applicable for/with any operating system and a reference to a specific operating system in this disclosure is merely an example, not a limitation.

Typical scheduling schemes for multi-virtual machine (VM) scenarios all use native hypervisor scheduling, which allocates scheduling resources to multiple VMs based on the capabilities of the hypervisor. The drawback of native hypervisor scheduling is that it must be set statically in advance. Whereas in reality, workloads in different VMs are changing all the time. Static native hypervisor scheduling cannot solve the problem of dynamic resource competition among multiple VMs at runtime.

The concepts, methods, and architecture described herein describe the novel concept of para-virtualized scheduling. In comparison to native hypervisor scheduling, para-virtualized scheduling allows primary VMs to dynamically decide the scheduling policy by putting together the sibling VMs and primary VMs′ own workloads and solves the runtime scheduling resource allocation problem that native hypervisor scheduling cannot.

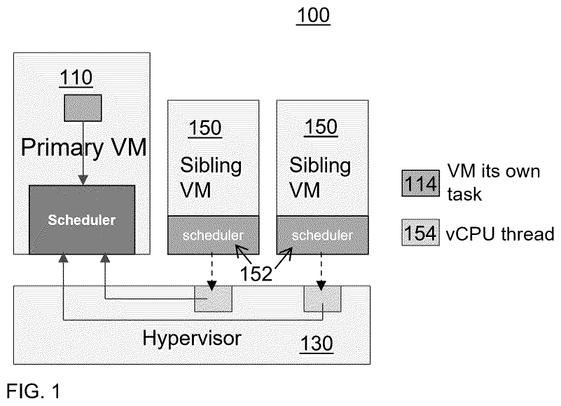

FIG. 1 shows para-virtualized scheduling architecture at a high level. FIG. 1 shows a system architecture 100 comprising a primary virtual machine (VM) 110, a hypervisor 130, and two sibling VMs 150. A primary VM (synonyms include main VM and lead VM) is a software emulation of a physical computer that operates as the main virtual system within a hypervisor environment. A sibling VM (synonyms include peer VM, application VM, and adjacent VM) is a virtual machine that shares the same physical resources as another VM. It typically operates concurrently with the primary VM. A hypervisor (synonyms include virtual machine monitor (VMM) and host machine) is a software layer that enables and manages virtual machines on a single physical host.

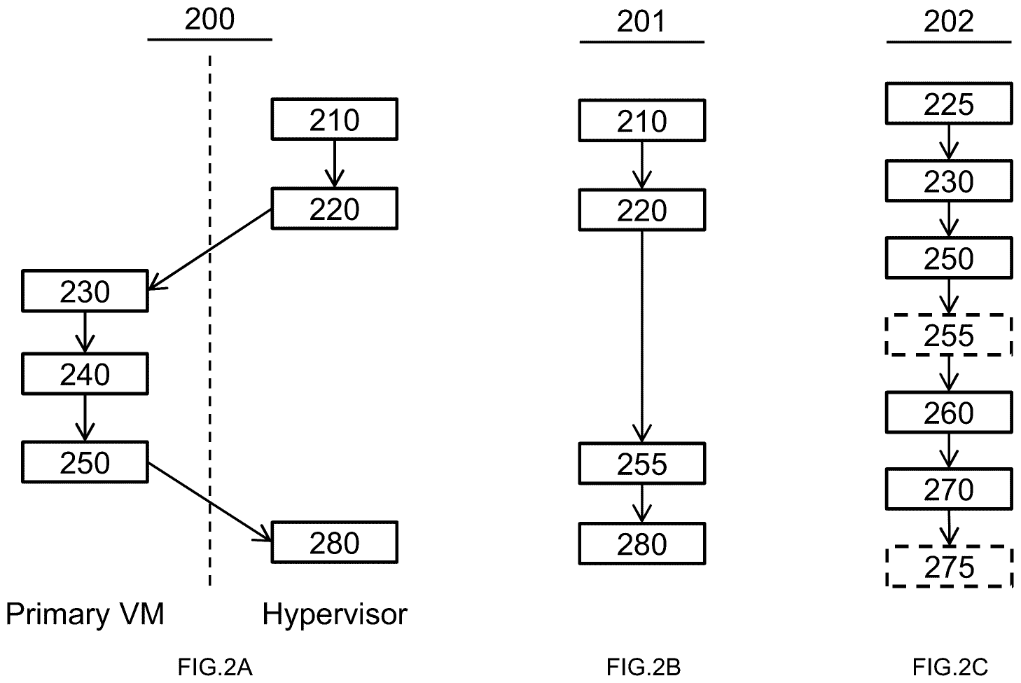

FIGS. 2A to 2C show block diagrams of methods for the para-virtualized scheduling.

FIG. 2A is a block diagram of a method 200 for a primary virtual machine (VM) to schedule a task from a sibling VM on a hypervisor. The method comprises creating 210, at the hypervisor, a sibling task requested by the sibling VM, wherein the sibling task comprises a hypervisor task ID created by the hypervisor. Communicating 220, from the hypervisor to the primary VM, a hypervisor task identification (ID) for the sibling task. Creating 230, at the primary VM, a broker task based on the hypervisor ID, wherein the broker task comprises a broker task ID and wherein the broker task corresponds to the sibling task. Creating 240, at the primary VM, a mapping of the broker task to the corresponding hypervisor task ID of the sibling task. Executing 250 the broker task at the primary VM. The method 200 further comprises executing 280 or running the sibling task at the hypervisor when notified by the primary VM, wherein the sibling task's execution at the hypervisor is triggered by the broker task according to the mapping.

In some embodiments, the broker task may be created by the hypervisor if requested by the primary VM. The primary VM may communicate to the hypervisor, a mapping of the broker task to the corresponding hypervisor task ID of the sibling task. The broker task may be executed at the hypervisor when chosen by a scheduler of the primary VM. When executed, the broker task may trigger the running of the sibling task at the hypervisor according to the mapping.

FIG. 2B is a block diagram of a method 201 for a hypervisor to schedule a plurality of tasks from a primary VM and a sibling VM. The method comprises creating 210 a sibling task requested by the sibling VM, wherein the sibling task comprises a hypervisor task ID created by the hypervisor. Communicating 220 the hypervisor task ID to the primary VM. Obtaining 255 a mapping of a broker task to the corresponding hypervisor task ID of the sibling task. The method 201 further comprises executing 280 or running the sibling task when notified by the primary VM; wherein the broker task triggers the running of the sibling task according to the mapping.

In another embodiment, the hypervisor may create a broker task requested by the primary VM, wherein the broker task corresponds to the sibling task, and wherein the broker task comprises a broker task ID created by the primary VM. The hypervisor may then obtain a mapping of the broker task ID to the corresponding hypervisor task ID of the sibling task. The method further comprises executing the broker task when notified by the primary VM (e.g. when chosen by a primary VM scheduler), wherein the broker task triggers the running of the sibling task according to the mapping.

FIG. 2C is a block diagram of a method 202 for a primary virtual machine (VM) to schedule a task from a sibling VM on a hypervisor. The method comprises obtaining 225, from the hypervisor 130, a hypervisor task identification (ID) for a sibling task, wherein the sibling task originated at the sibling VM 150. The method then comprises creating 230 a broker task 114 based on the hypervisor task ID, wherein the broker task comprises a broker task ID and the broker task corresponds to the sibling task. The method next comprises communicating 250 a mapping of the broker task ID to the corresponding hypervisor task ID of the sibling task. The method then comprises executing 260 or running the broker task in the primary VM when chosen by a primary VM scheduler. The method next comprises notifying 275 the hypervisor to run the sibling task which is mapped to the broker task in the primary VM. The method next comprises executing 280 or running the sibling task at the hypervisor when notified by the primary VM. This method allows for a primary VM to schedule sibling VM tasks on the hypervisor without compromising the security of the virtualized environment.

In another embodiment, the method comprises communicating a mapping of the broker task ID to the corresponding hypervisor task ID of the sibling task to the hypervisor. The method further comprises notifying the hypervisor to run the broker task when chosen by a primary VM scheduler.

According to an embodiment of the method, the primary VM may be on a system further comprising the sibling VM and the hypervisor, wherein the primary VM administrates the system, controls the allocation of the system's resources, and manages the creation and destruction of the sibling VM.

A primary VM is a virtual machine that resides on the system and is responsible for system administration, controlling the allocation of system resources, and managing the creation and destruction of other sibling virtual machines. A sibling VM is a lightweight virtual machine (which can also be referred to as an application VM) that is created for special purposes and does not reside permanently, but only runs specific workloads in the virtualization environment for isolation purposes.

A primary VM may be responsible for managing the most resources of the entire system. This is especially true in thin-client virtualization computing environments, such as Linux-based web or netbooks. Here, a primary virtual machine (VM) operates as the central controller of the system, managing the overall functionality and user interface. This may include managing certain central processing unit (CPU) resources, memory allocation, power management, and peripheral device access.

This primary VM orchestrates the device's higher-level operations, including the execution of various applications and browser tabs. Each application or tab may be within its own separate, isolated virtual environment, known as a sibling VM. These sibling VMs are managed and supervised by the primary VM. A primary VM may also be responsible for their creation or destruction. Running an application or tab in a VM ensures that it functions independently and securely, without direct interaction with the core system or other applications. This architecture enhances security and stability, as issues in one sibling VM do not directly impact the primary VM or other sibling VMs. This setup is typical in lightweight, web-centric computing devices designed for streamlined, internet-based tasks and applications, emphasizing security, efficiency, and ease of use within a virtualized environment.

Due to the isolated nature of the virtualized environment, a primary VM has no direct control over the scheduling of sibling VMs. So sibling VMs compete for CPU resources amongst themselves as well as with the primary VM. Although the creation and destruction of sibling VMs can often be controlled by the primary VM, the CPU resources consumed by sibling VMs while running are out of the primary VM's control. As shown in FIGS. 1 and 2, the primary VM can decide the scheduling policy for most workloads in the system both in the primary VM and outside the primary VM by communicating with the hypervisor.

Para-virtualized scheduling keeps the two schedulers of the hypervisor and the primary VM. The method then asks the scheduler of the primary VM to schedule the vCPU threads of sibling VMs on the hypervisor. This minimizes disruptive modifications and can benefit the widely used Linux general virtualization architecture (i.e., KVM-based VMs).

In this method, the sibling task may be a virtual thread of the sibling VM 154. A virtual thread (synonyms include vCPU thread and VM thread) is a sequence of executable instructions for a simulated processor core. A VM creates a task or thread representing a specific operation or process that runs within the virtualized environment. The VM then schedules it to be run on the simulated CPU. The hypervisor then creates and manages the virtual thread corresponding to the VM's task. The hypervisor then allocates and schedules real processor resources to VMs utilizing the vCPU threads assigned to that VM for execution and processing.

In an embodiment of the method, only the vCPU threads of the sibling VMs may be required to be scheduled by the primary VM. This allows the hypervisor to continue to schedule tasks that do not belong to the purview of the primary or sibling VMs, rather than requiring the primary VM to schedule all tasks on the hypervisor. Limiting scheduled sibling tasks to virtual threads also minimizes intrusive modifications to the scheduler.

The method and the solutions disclosed herein may solve scheduling optimization issues in multi-VM scenarios. In particular, it may solve the issue of scheduling other sibling VMs by primary VMs. The solutions disclosed herein may optimize the performance of current and future OSs based on multi-VM architecture.

The method may further involve a primary VM obtaining workload information about the sibling task from the sibling VM. Workload information (synonyms include task metrics and processing data) is data pertaining to the processing requirements and characteristics of a task within a VM.

When obtaining workload information, the primary VM scheduler may select the broker task for execution based on this information. A broker task (synonyms include proxy task and representative task) is a task created in primary VM to represent and manage another task (sibling task) in a virtualized environment.

A primary VM scheduler 112 (synonyms include VM task manager and virtual scheduler) is the scheduling component within the primary VM responsible for task allocation and management. Each sibling VM also has a scheduler 152.

VMs that are responsible for managing system resources and must reside on the system are primary VMs, while VMs that have specific usage scenarios or run only specific applications and are not responsible for managing system resources are sibling VMs.

According to an embodiment of the method, the primary VM and the sibling VM are deprivileged. A virtual machine runs at a non-root mode, and under a non-root mode, privileged level commands and special events can be captured by a hypervisor to secure the system. Such a de-privilege feature of virtual machines is also important for securing the system.

The solution in accordance with the method and the examples disclosed herein is called “para-virtualized scheduling.” “Para-virtualized” means virtualized in a para-virtualization way. In other words, it requires modifications to the Guest mode in Linux. As shown in FIG. 1, para-virtualized scheduling allows primary VMs to schedule sibling VMs and dynamically decide the scheduling policy by putting together the sibling VMs and primary VMs' own workloads and solves the runtime scheduling resource allocation problem that native hypervisor scheduling cannot.

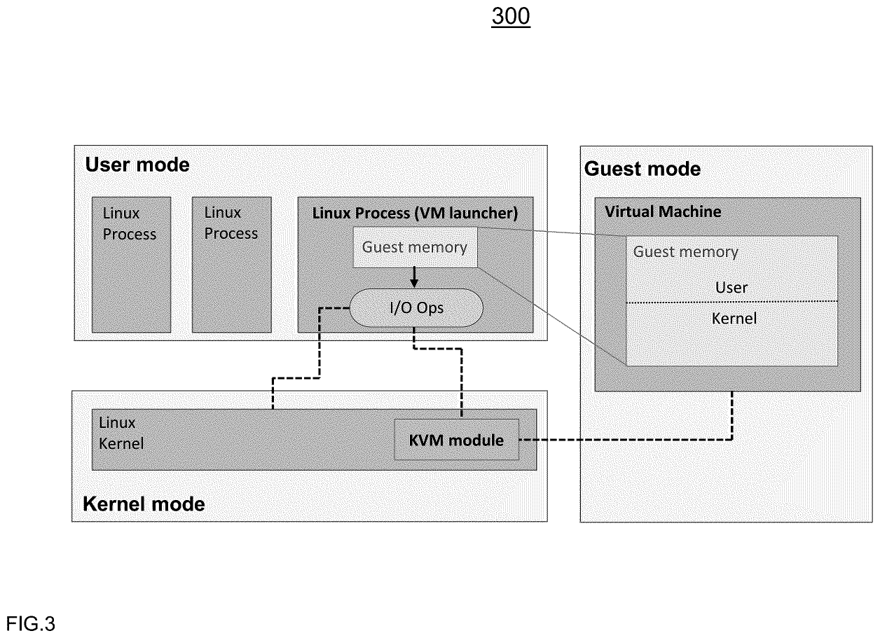

More details and optional aspects of FIGS. 1 and 2A to 2C may be described in connection with examples described below (e.g., FIGS. 3 to 18).

FIG. 3 shows an overview 300 of a kernel-based virtual machine module (KVM) architecture. As shown in FIG. 3, the Linux system widely uses the KVM-based virtualization architecture, in which the VM virtual CPUs (vCPU) run as the threads on the hypervisor.

When it comes to the virtualization architecture of the client scenario, it is often necessary to have a primary virtual machine to control the overall system resource. It is common to put most of the workload in the primary VM and give almost all resources (except the physical CPU resource due to “double scheduling”) to the primary VM. For specific workloads that require isolation protection, they will be put in the sibling VM to run. Consequently, there will be only a few tasks on the hypervisor. Moreover, these hypervisor tasks are only in response to some events, do not run for a long time, and do not significantly affect the running of the workload in the VMs.

In such a typical virtualization architecture, two scheduling issues affect the performance of the primary VM and the sibling VM. The first is the CPU resource contention problem caused by dual scheduling. The second is difficulty in controlling and optimizing the sibling VM's PnP (power and performance) and UX (user experience).

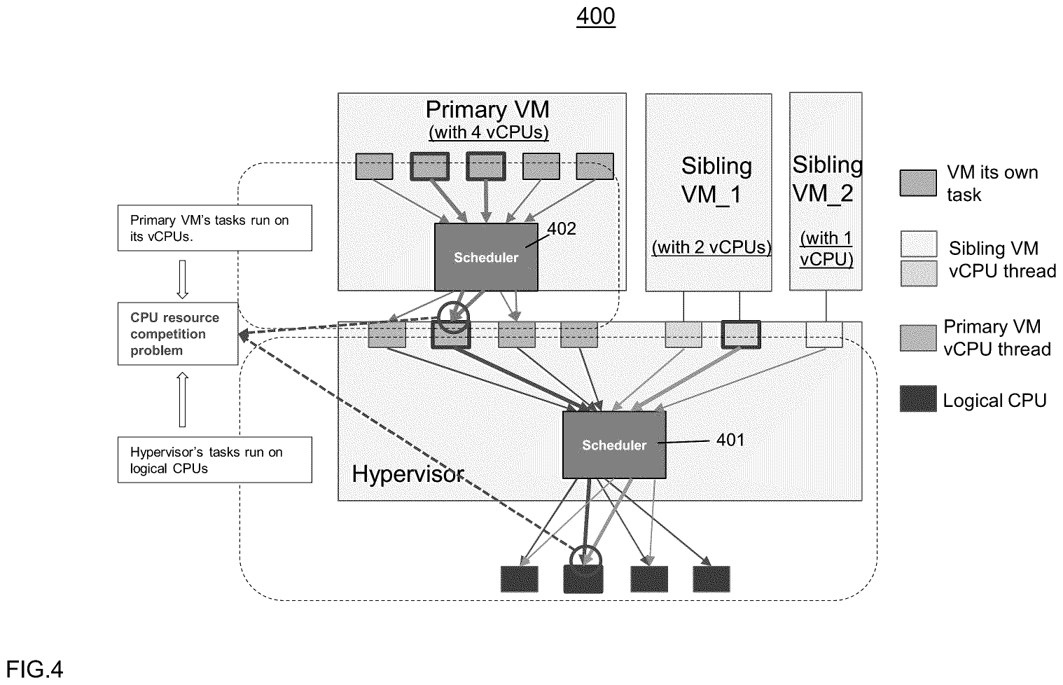

More details and optional aspects of FIG. 3 may be described in connection with examples described above (e.g., FIG. 1 to 2) or below (e.g., FIGS. 4 to 18).

FIG. 4 shows the first scheduling issue 400, the CPU resource competition problem caused by double scheduling. “Double scheduling” means that there are two schedulers. One is the hypervisor scheduler 401, which schedules the virtual CPUs on the host's physical CPUs, and another is the VM scheduler 402, which schedules the guest OS tasks on the guest's virtual CPUs. Since these two schedulers are independent of each other, neither the workload balancing mechanism in the primary VM nor in the hypervisor can work at the system level, nor can they even cooperate with each other. This fact will bring serious competition problems to the VM scheduling resource. For example, the primary VM and the sibling VM will have strong competition when running CPU-intensive workloads at the same time.

The hypervisor cannot solve these contention problems because, in most architectures, the VM does not tell the hypervisor what workloads it is running. From a client virtualization scenario design perspective, users always want a thinner hypervisor that makes it easier to audit code for security and safety. At these points, the hypervisor's scheduling cannot be relied on to eliminate competition between different VMs.

On the other hand, usually, the primary VM can get workload hints from sibling VMs through various Quality of Service (QoS) based on inter-VM communication mechanisms on the Linux platform. With the hints provided by QoS, the sibling VM (mainly the vCPU threads of the sibling VM) and the workloads of the primary VM can be combined and handed over to the scheduler of the primary VM for scheduling. Then the workload balancing mechanism of the scheduler of the primary VM may be used to solve the CPU competition problem.

Although there is still double scheduling between the sibling VM and the hypervisor, there will not be as many workloads in the sibling VMs as in the primary VMs, so it is enough to consider the primary VM to schedule the sibling VM's vCPU threads.

The second scheduling issue is that it is difficult to control and optimize sibling VM's PnP (Power and performance) and UX (User Experience). The client scenario is power-sensitive and UX-sensitive. In the typical architecture, almost all devices are passed through to the primary VM, so power control of the device is the responsibility of the primary VM. CPU PnP management (such as p-state, and c-state) is also usually managed by the primary VM rather than the hypervisor because most workloads run in the primary VM rather than on the hypervisor.

In this case, since the primary VM cannot schedule the sibling VM, it is difficult to have a suitable solution to support the PnP management of the sibling VM without conflicting with the PnP of the primary VM.

On the other hand, it is also difficult to optimize the UX for the sibling VM. In the client scenario, UX refers to interactivity, especially response speed. For the general client virtualization architecture, the scheduling and response optimizations for the graphical interface, and front-end workload are all placed in the primary VM. Therefore, if the primary VM cannot directly schedule the sibling vCPU, the interactivity of the workload in the sibling VM will be severely degraded.

To overcome these two scheduling issues, two approaches have been used for Linux systems. One, using the cgroup mechanism on the hypervisor to statically divide the proportion of time slice that different VMs can run. Two, setting the VM's vCPU thread can be with real-time priority or be set with the lower nice value to own the longer time slice.

In the first approach, for a system running the Linux operating system (OS), the cgroup mechanism on the hypervisor is used to statically divide the proportion of time slices that different VMs can run. The disadvantage to this solution is the cgroup must be set after the virtual CPU (vCPU) thread is created. The specific ratio is pre-divided according to experience, and the primary VM cannot dynamically adjust the setting on the hypervisor.

In the second approach, for a Linux system, the VM's vCPU thread can be set with real time priority or be set with the lower nice value to own the longer time slice. The disadvantage to this solution is that real-time priority and the nice value on the hypervisor cannot be dynamically adjusted by the primary VM. These solutions define passive scheduling policies for vCPU threads of VMs, and these policies are mostly static and should be set statically by a hypervisor in advance, whereas in reality, workloads in different VMs are changing all the time.

In the general architecture, because the hypervisor cannot know the specific workload information in the VM, the hypervisor cannot effectively optimize the scheduling of vCPU threads by these passive policies.

Based on the above two typical issues related to scheduling, example methods, and systems are disclosed herein to allow the primary VM to schedule sibling VMs to solve those problems.

The methods and disclosure recited herein allow the scheduler of the primary VM to be aware of the existence of the vCPU threads of the sibling VM and set the scheduling policies for the sibling VM, and then control the scheduling of the vCPU threads of the sibling VM through the scheduling mechanism in the user space of the hypervisor.

The primary VM may comprise a special scheduling unit, which has 1:1 mapping of the sibling VM's vCPU, and with this special scheduling unit, the primary VM scheduler can make scheduling decisions with the help of an extended Berkeley Packet Filter (eBPF) hook for the sibling VM's vCPUs to achieve primary VM scheduling sibling VM. eBPF is a powerful and flexible technology in the Linux kernel that allows for the dynamic insertion of bytecode into the kernel. This bytecode is executed in response to various events, such as network packets arriving or syscalls being made, enabling custom and efficient kernel-level operations. eBPF impacts aspects of system performance monitoring, networking, and security, as it provides a safe way to extend kernel capabilities without modifying kernel source code or loading kernel modules.

In addition, virtual registers defined by a virtual machine monitor of the hypervisor(such as virtual model-specific registers (MSRs)) can be used. Using a virtual MSR-based scheduling control and the user space, a simple scheduling framework may allow cooperation between the primary VM scheduler and the hypervisor scheduler.

These solutions provide a VM scheduling model that allows a primary VM to handle system-wide scheduling with other sibling VMs, for example on a Linux system. The implementation of this solution mainly focuses on the user space of the primary VM and the hypervisor and may only require small modifications to the Linux kernel, so it has strong flexibility and portability. It may improve virtualization architectures to achieve the best performance and power consumption on computing platforms.

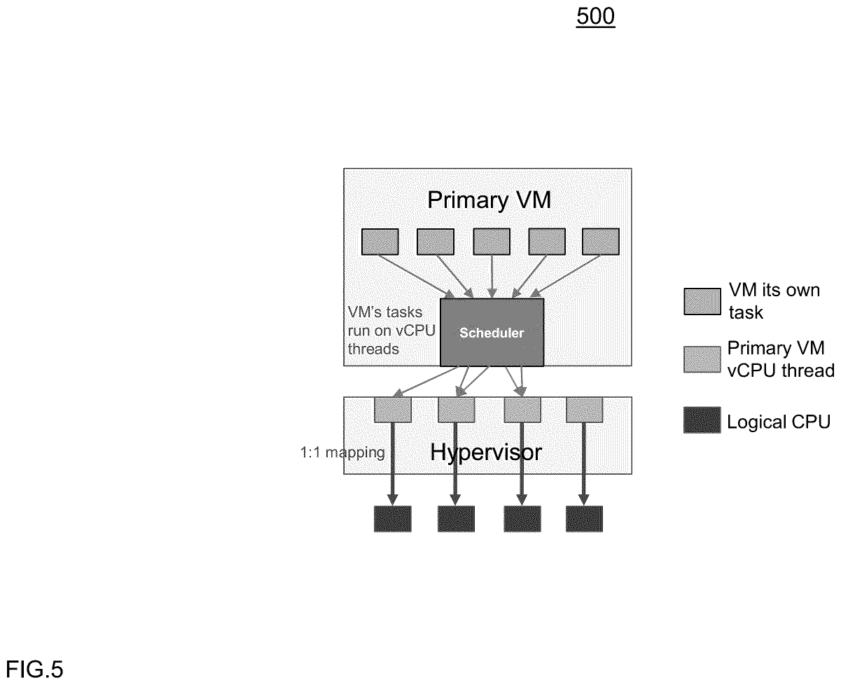

More details and optional aspects of FIG. 4 may be described in connection with examples described above (e.g., FIG. 1 to 3) or below (e.g., FIGS. 5 to 18).

FIG. 5 shows an example 500 of regular primary virtual machine (VM) architecture. Many platforms are opting for a virtualization architecture. The typical virtualization architecture in these scenarios consists of a primary virtual machine (VM), a thin hypervisor with minimal functionality, and several other sibling VMs. All workloads will run in the VMs, so there will be few tasks on the hypervisor, and those tasks will be in response to a few events, will not run for long, and will not significantly impact the execution of the workload in the VMs. The primary VM will have as many vCPUs as physical CPUs, and each vCPU will be bound one-to-one to a physical CPU, as shown in FIG. 5 so that the primary VM can better allocate physical CPU resources to its workloads.

However, due to the existence of double scheduling, the primary VM and the sibling VM will have a severe contention problem when running CPU-heavy workloads at the same time. A solution to the doubling scheduling problem between the primary VM and the hypervisor is to allow the primary VM to schedule the sibling VMs. In KVM-based virtualization architecture, the implementation of the primary VM scheduling the sibling VM has always been a very difficult problem. Completely removing the scheduler from the hypervisor to let the primary VM schedule the entire system is very disruptive and unrealistic.

Through para-virtualized scheduling, several mechanisms may be combined to coordinate the scheduler of the primary VM and the scheduler of the hypervisor and to minimize the invasive modification of the kernel. According to the methods described herein, the hypervisor scheduler will cooperate with the primary scheduler's strategy, and any kernel modifications will not significantly change the logic of the scheduler itself. The implementation of this solution mainly focuses on the user space of the primary VM and the hypervisor and only requires small modifications to the Linux kernel, so it has strong flexibility and portability.

More details and optional aspects of FIG. 4 may be described in connection with examples described above (e.g., FIG. 1 to 3) or below (e.g., FIGS. 5 to 18).

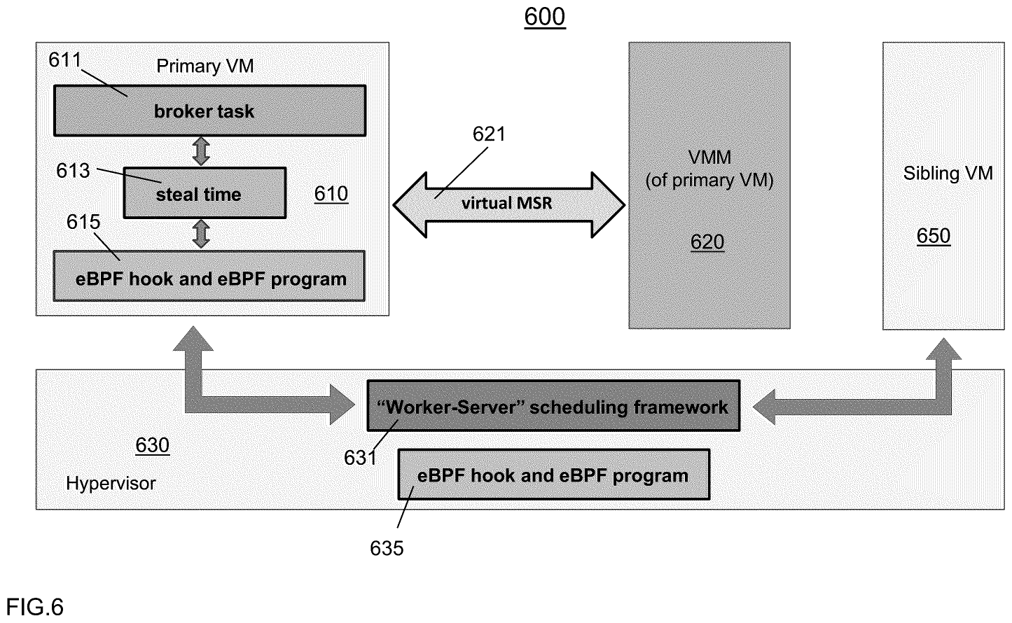

FIG. 6 shows components of para-virtualized scheduling 600 in accordance with one example. Para-virtualized scheduling comprises the following elements or modules as shown in FIG. 6: a broker task 611 in primary VM 610, Steal time for per task 613 in primary VM 610, eBPF-driven scheduling enhancements 615, 635 in the primary VM 610 and hypervisor 630, “Worker-Server” Scheduling Framework 631 Integrated in vCPU Implementation of the hypervisor 630, Virtual MSR 621 based Paravirtualized Scheduling Control.

To allow the scheduler in the primary VM to be aware of specific tasks on the hypervisor, and to further convert these tasks into the primary VM's “sched_entity” (the “sched_entity” is the smallest unit scheduled in the Linux kernel), a “broker task” 611 mechanism is introduced in the primary VM 610. This mechanism can map the tasks on the hypervisor to the primary VM. In other words, a so-called “broker task” is created in the VM to map 1:1 with the vCPU threads of the sibling VMs 650 on the hypervisor 630. The difference between “broker task” and other native tasks is that it is essentially just a fake scheduling unit, and does not run specific workloads, but provides its own scheduling information (such as priority, cgroup settings, etc.) to let the scheduler (mainly the CFS scheduler) in the primary VM divide specific time slices. When it is scheduled, all it needs to do is trap to the hypervisor and pass the time slice information to the task on the hypervisor, and let the task on the hypervisor run the real workload instead of it.

A per-task steal time concept 613 is introduced in the primary VM 610 in para-virtualized scheduling. Steal time plays a big role in VMs (especially in scheduling). Unlike the classic steal time concept, where the classic steal time is for the logical CPU used to represent the time spent by the physical CPU running other sibling VMs (i.e., the time the current VM is being stolen), the per-task steal time introduced here is for the task in the VM. Since the actual execution of the workload represented by the broker task is performed outside the VM, (i.e., on the hypervisor) the runtime of the broker thread is stolen by the hypervisor. Therefore, a fine-grained steal time element is required, which is the task-level steal time, to the scheduler in the primary VM to make scheduling decisions.

To minimize intrusive modifications, changes to the scheduler may be integrated into the eBPF program 615, 635 (including the primary VM and hypervisor). This requires the addition of eBPF hooks at key points in the scheduler. Only two hooks may be required, one for both the primary VM and the hypervisor, and one for the primary VM only. This may minimize the modification of the scheduler and take advantage of eBPF's scheduling logic, which is highly flexible and has low overhead. The modifications monitor specific tasks through these eBPF hooks and calculate or apply per-task steal time information for these specified tasks.

Whether it is the eBPF program of the primary VM or the eBPF program of the hypervisor attached to these two hooks, it will only affect the time slice calculation of a specific task (in the primary VM, it will affect the broker task, and on the hypervisor, it will affect only the task that has a broker task in the VM). At most, this effect uses the steal time-related information in the eBPF to provide time slice-related hints to the scheduler. The logic of the scheduler itself is not changed.

In another embodiment of the method, a virtual thread of the primary virtual machine is registered as a server and the virtual thread of a sibling virtual machine is registered as a worker.

A thread scheduling framework 631 may be used to schedule vCPU threads. This framework is built into the vCPU implementation of the virtual machine monitor (VMM) on the hypervisor user space. It allows registration of the vCPU threads of the primary VM as “servers” and the vCPU threads of the sibling VMs as “workers”. This thread scheduling framework is very lightweight. It mainly implements the following three scheduling logics: First, a server thread is bound to multiple worker threads, and the server can pick workers to run. Second, when a worker is picked, it will be woken to run, and its server will sleep. Third, when a worker sleeps, its server will be woken. This is a lock-based synchronization model. In the user space of the Linux system, it may be implemented through the futex mechanism.

In another embodiment of the method, the primary VM communicates with the hypervisor via a set of virtual registers. The virtual registers may be virtual model-specific registers of a virtual machine monitor.

To help the primary VM control the hypervisor scheduling, a virtual register or MSR set may be introduced in the primary VM. The virtualized MSRs here may be memory-based MSRs added to the primary VM that are not real MSRs. Reading and writing to them from the primary VM causes a VM exit. Then the trap of RDMSR and WRMSR is handled and emulated in the user space of the hypervisor by the VMM. This set of virtual MSRs is used to register broker tasks and pass scheduling hints to the hypervisor, which requires minor modifications to the primary VM.

According to the process sequence of para-virtualized scheduling, the following sections describe the design of the above modules in detail with implementation examples. However, other implementations of virtual MSR and eBPF hook definitions are possible. The examples listed herein only illustrate the concepts disclosed herein. Actual definitions may differ from (and should not be limited to) the examples disclosed herein.

The control of paravirtualized scheduling defines the interaction mechanism between the primary VM and the hypervisor. Three communication scenarios between primary VMs and hypervisors, especially the virtual machine monitor (VMM) on the hypervisor user space, may be considered. First, the primary VM should know which sibling VMs′ vCPU threads on the hypervisor it can schedule. Second, the primary VM should build the mapping between the broker tasks in the VM and hypervisor tasks. Third, the primary VM tells VMM on the hypervisor about which hypervisor task needs to run next and how long it can run.

Based on these considerations, a set of virtual MSRs may be defined for the primary VM to interact with the hypervisor and control scheduling.

Using virtual MSRs allows the custom scheduling coordinator in the primary VM can read and write these MSRs in the user space, at the same time, the hypervisor VMM can also handle the VM EXIT captured by WRMSR/RDMSR in the hypervisor user space (this is the mechanism of KVM) to obtain or deliver relevant information to the primary VM.

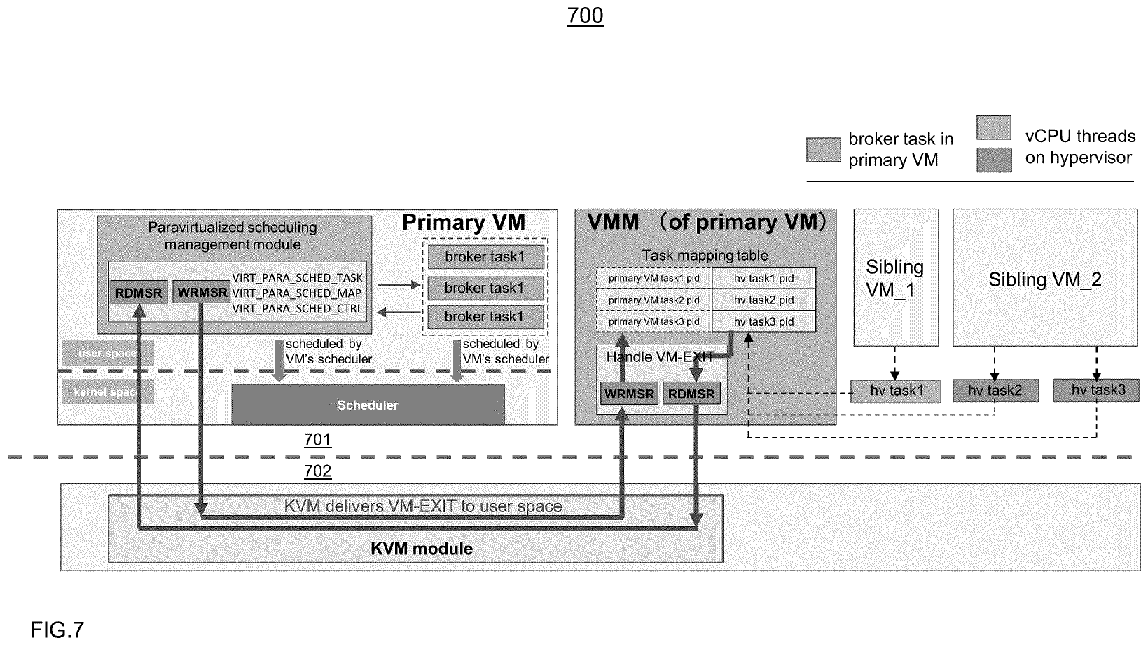

Thus, all communication, interaction, and control are put in user space (both primary VM user space and hypervisor user space) without modifying the Linux kernel as shown in FIG. 7. This brings great flexibility and can be easily ported to different Linux-based virtualization environments.

More details and optional aspects of FIG. 6 may be described in connection with examples described above (e.g., FIG. 1 to 5) or below (e.g., FIGS. 7 to 18).

FIG. 7 shows a main process 700 of the virtual MSR mechanism in accordance with one example (based on the example virtual registers below). These virtual registers or MSRs may be defined using the physical addresses of the primary VM. Nothing must be stored in these physical addresses. Only the triggering of a VM exit through WRMSR and RDMSR, and then simulation through VMM in user space is required.

As the example, virtual MSRs may be defined as:

(Example) VIRT_PARA_SCHED_TASK: list hypervisor tasks.

(Example) VIRT_PARA_SCHED_MAP: build the mapping between the hypervisor task and the broker task.

(Example) VIRT_PARA_SCHED_CTRL: deliver scheduling hints to the hypervisor.

Their addresses could be as Table 1. Table 1 shows an example of virtual MSRs' addresses based on a specific OS. It should be noted that the addresses here are not used by the virtual MSRs in KVM (Linux v6.4).

TABLE 1

| Register Name | Address |
|---|---|
| VIRT_PARA_SCHED_TASK | 4B564D09H |
| VIRT_PARA_SCHED_MAP | 4B564D0AH |
| VIRT_PARA_SCHED_CTRL | 4B564D0BH |

The para-virtualized scheduling control flow in FIG. 7 uses these 3 virtual MSRs as an example to explain how works specifically. Specifically the flow shows how the KVM delivers a VM-Exit to user space 701 through kernel space 702. The virtual MSRs defined in the actual implementation are not necessarily as shown in the examples.

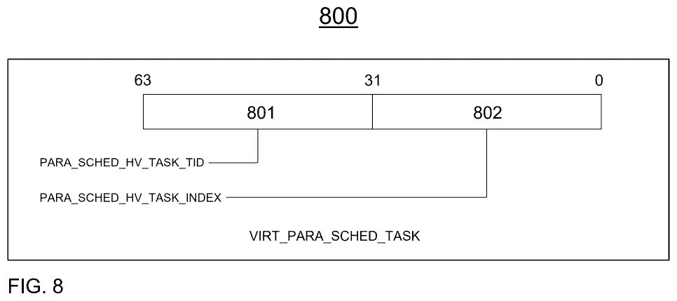

More details and optional aspects of FIG. 7 may be described in connection with examples described above (e.g., FIG. 1 to 6) or below (e.g., FIGS. 8 to 18).

FIG. 8 shows an example structure of VIRT_PARA_SCHED_TASK 800 in accordance with one example. VIRT_PARA_SCHED_TASK MSR allows the primary VM to obtain all tasks on the hypervisor that need to be scheduled by traversing the index. This MSR has two fields 801, 802, and these two fields have the following relationship:

When FFFFFFFFH is written into PARA_SCHED_HV_TASK_INDEX (bits [0:31]), the value in this field will be corrected to the maximum number of tasks currently registered with the hypervisor. Meanwhile, the value in PARA_SCHED_HV_TASK_TID (bits [32:63]) will be cleared to zero.

When a valid value (less than the actual maximum number of tasks) is written into PARA_SCHED_HV_TASK_INDEX (bits [0:31]), then a valid task tid on hypervisor can be read from PARA_SCHED_HV_TASK_TID (bits [32:63]).

When any value greater than or equal to the actual maximum number is written into PARA_SCHED_HV_TASK_INDEX (bits [0:31]), the value of PARA_SCHED_HV_TASK_INDEX will be corrected to the maximum number. Meanwhile, the value in PARA_SCHED_HV_TASK_TID (bits [32:63]) will be cleared to zero.

Here, the tid (thread id: a concept in the Linux system to identify threads) is received from this MSR on the hypervisor, which has no practical role in the primary VM. However, this tid can be used to refer to the tasks on the hypervisor, and at the same time, the primary VM can be aware of the existence of these tasks that need to be scheduled on the hypervisor.

According to the characteristics of the two fields of this MSR, an algorithm to enumerate the tasks that need to be scheduled on the hypervisor may be obtained. An Example to enumerate the tid of the sibling VM vCPU from VIRT_PARA_SCHED_TASK is shown below.

```
// Write FFFFFFFFH into VIRT_PARA SCHED_TASK to get the maximum number
// of hypervisor tasks that need to be scheduled by primary VM.
WRMSR(VIRT_PARA_SCHED_TASK, FFFFFFFFH);
DWORD MaxHvTaskNum = RDMSR(VIRT_PARA_SCHED_TASK);
DWORD HvTaskIdx; // Write into the PARA_SCHED_HV_TASK_INDEX field (lower 32 bits of VIRT_PARA_SCHED_TASK).
DWORD HvTaskTid; // Read from the PARA_SCHED_HV_TASK_TID field (higher 32 bits of VIRT_PARA_SCHED_TASK).
// Enumerate all hypervisor tasks by incrementing the index.
For (HvTaskIdx = 0; HvTaskIdx < MaxHvTaskNum; HvTaskIdx++) {
  // Write index into the PARA_SCHED_HV_TASK_INDEX field (lower 32 bits).
  WRMSR(VIRT_PARA_SCHED_TASK, HvTaskIdx);
  // Get the pid of hypervisor task from PARA_SCHED_HV_TASK_TID field (higher 32 bits).
  HvTaskTid = RDMSR(VIRT_PARA_SCHED_TASK) >> 32;
  // The method defined by the primary VM itself.
  // Store the tids of hypervisor tasks that need to be scheduled by primary VM.
  // Create the corresponding broker tasks to allow the scheduler of primary VM to schedule.
  StoreAndCreateBrokerTask(HvTaskTid);
}
```

This enumeration mechanism may be more suitable to be implemented with instruction primitives, but under the KVM-based virtualization architecture, virtual MSRs are easier to handle and more flexible than virtual instructions.

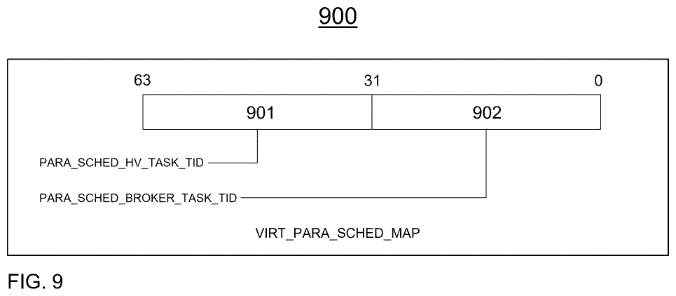

More details and optional aspects of FIG. 8 may be described in connection with examples described above (e.g., FIG. 1 to 7) or below (e.g., FIGS. 9 to 18).

FIG. 9 shows an example structure of VIRT_PARA_SCHED_MAP 900. According to another embodiment, the primary VM receives the hypervisor ID and provides the mapping via the set of virtual registers.

After the primary VM obtains the hypervisor tasks tid (the tid of the vCPU threads of the sibling VMs) from VIRT_PARA_SCHED_TASK MSR, broker tasks may be created for these hypervisor tasks. Next, the primary VM can create a mapping between broker tasks in the primary VM and scheduled tasks on the hypervisor using VIRT_PARA_SCHED_MAP MSR.

The primary VM writes the tids of the broker task 901 and the corresponding hypervisor task 902 into the VIRT_PARA_SCHED_MAP MSR, and the VMM gets this mapping relationship when it handles the WRMSR of this MSR in the hypervisor user space.

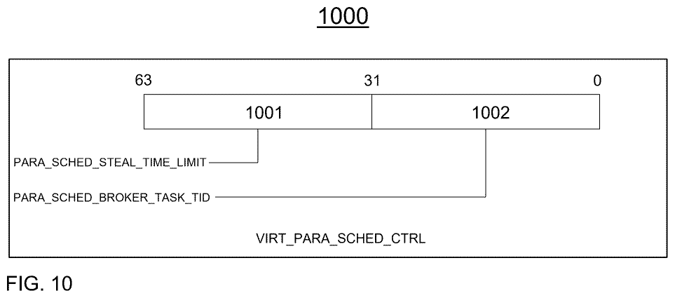

More details and optional aspects of FIG. 9 may be described in connection with examples described above (e.g., FIG. 1 to 8) or below (e.g., FIGS. 10 to 18).

FIG. 10 shows an example structure of VIRT_PARA_SCHED_CTRL 1000. The method may further comprise computing 255 a predictive time slice for the broker task and the corresponding sibling task and communicating 275 the predictive time slice to the hypervisor when the broker task is chosen to run by the primary VM scheduler.

A predictive time slice (synonyms include estimated execution window and forecasted time allotment) may be a calculated duration for task execution, estimated based on various factors like workload and system capacity.

The primary VM can provide the scheduled time information of a broker task to the VMM on the hypervisor through the VIRT_PARA_SCHED_CTRL MSR. This MSR has two fields: PARA_SCHED_BROKER_TASK_TID 1002 and PARA_SCHED_STEAL_TIME_LIMIT 1001.

The hypervisor may provide timing information to the primary VM. The predictive time slice may be computed based on timing information obtained from the hypervisor. When the primary VM selects a broker task to run, the broker task writes its tid and time slice (computed by an eBPF hook) to this MSR. The VMM can use this time slice to schedule the corresponding sibling VMs′ vCPU threads on the hypervisor.

When the broker task reads this MSR, it returns the remaining time slice. This remaining time slice refers to the remaining time obtained by subtracting the written limit of the steal time (this is the first time slice assigned by the CFS scheduler) from the actual execution time of the vCPU thread of the corresponding sibling VMs, and the remaining time slice will not be less than 0.

The remaining time slice is calculated by the VMM on the hypervisor. The VMM obtains the runtime statistics from the eBPF program and then returns the remaining time slice to the primary VM when emulating the RDMSR.

The broker task in the primary VM represents the vCPU threads of the sibling VMs on the hypervisor to facilitate scheduling by the scheduler in the primary VM. Here, the scheduler in the primary VM schedules the broker task and assigns time slices to the broker task but does not directly control the vCPU threads of the sibling VMs on the hypervisor.

The paravirtual scheduling mechanism obtains the time slice calculated by the primary VM's scheduler for the broker task. Once the broker task is scheduled, that is, the broker task is selected to run, then the virtual MSR mechanism (disclosed above) communicates the tid of the broker task and the corresponding time slice to the VMM on the hypervisor. And then the VMM finds the hypervisor task to run according to the mapping relationship between the broker task and the hypervisor task.

Finally, the vCPU threads of the sibling VMs are scheduled to run using the user-space framework as explained above.

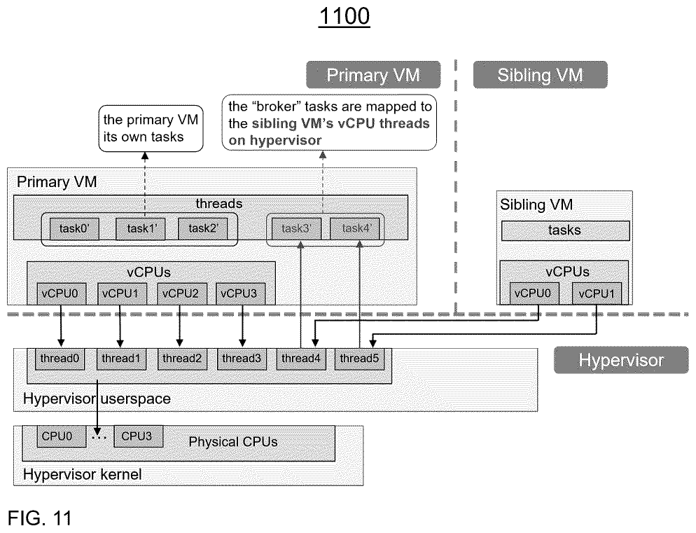

More details and optional aspects of FIG. 10 may be described in connection with examples described above (e.g., FIG. 1 to 9) or below (e.g., FIGS. 11 to 18).

FIG. 11 shows a mapping 1100 between the broker task and the sibling VM's vCPU thread in accordance with one example. As shown in FIG. 11, the broker task represents the vCPU threads of sibling VMs. Broker tasks are mainly used to represent tasks that need to be scheduled by the scheduler of the primary VM.

From the point of view of the scheduler in the primary VM, the broker task is no different from any other normal task because it does not require any special settings or modifications in the scheduler. The special thing about the broker task is the content running in it.

According to an embodiment of the method, the hypervisor may provide timing information to the primary VM. The timing information received by the primary VM may comprise a nice value of the broker task and queue information of a hypervisor scheduler.

The purpose of introducing the broker task in the primary VM is to get the time slice assigned by the scheduler of the primary VM for the broker task. Users can usually set different nice values (i.e., the concept of priority in the Linux scheduler) or CPU subgroup of cgroup for broker tasks. The settings of these scheduling policies affect the length of the time slices that the broker task gets in the scheduler, just like the regular task.

In the scheduler, the time slices are not predefined and cannot be read directly through an existing interface. Thus, an eBPF hook may be added to scheduler that predicts the length of the time slice that the broker task is assigned to when the broker task is selected to run.

The time slice here means the absolute length of time, so that hypervisor task can inherit and execute such a time slice from the corresponding broker task.

When the vCPU threads of the sibling VMs on the hypervisor are recognized by the primary VM in the form of broker tasks, the time slices assigned by the primary VM scheduler to these broker tasks can reflect that the primary VM has complete control over the physical CPU resources, which effectively avoids resource contention caused by double scheduling.

The hypervisor may receive a predictive time slice for the broker task based on the timing information, wherein the broker task triggers the running of the sibling task according to the predictive time slice.

The broker task traps the para-virtualized scheduling hints, including time slice information obtained from the eBPF program along with its own tid (thread id), to the hypervisor by writing these hints into the VIRT_PARA_SCHED_CTRL MSR, and finally these hints are notified to the VMM. Therefore, the broker task can be implemented as a loop as shown below. An Example of a broker task loop is shown below.

```
// The time slice assigned by the primary VM for the broker task.
// The broker task's priority and cgroug settings affect its time slice length.
// Sibling VM can notify primary VM to adjust the priority of the broker task corresponding to
// its vCPU through the QoS mechanism to adjust the sibling VM's performance.
DWORD BrokerTaskTimeSlice;
// The time slice of the broker task is consumed by the corresponding vCPU of the Sibling
// VM on the hypervisor.
// The actual running time of vCPU on the hypervisor is the time when the broker task is
// stolen, that is, broker task's steal time.
DWORD BrokerTaskStealTime;
// Get broker task's thread id through a Linux system call.
DWORD BrokerTaskTid = syscall(SYS_gettid);
While true; do
  // Before the broker task runs, the eBPF hook in the scheduler will pre-calculate the time
  // slice.
  // This calculated time slice can be obtained from eBPF progrom.
  BrokerTaskTimeSlice = eBPFGetTimeSlice(BrokerTaskTid);
  // Broker task delivers its time slice to the corresponding vCPU of sibling VM.
  // This WRMSR will cause VM-EXIT and the corresponding vCPU will run.
  WRMSR(VIRT_PARA_SCHED_CTRL, BrokerTaskTimeSlice << 32 | BrokerTaskTid);
  // After vCPU runs out of time slice, vCPU will return to the broker task.
  // Broker task gets the actual running time of vCPU on the hypervisor .
  BrokerTaskStealTime = RDMSR(VIRT_PARA_SCHED_CTRL) >> 32;
  // Broker task tells primary VM's scheduler its actual running time through an eBPF
  // hook.
  eBPFDeliverStealTime(BrokerTaskTid, BrokerTaskStealTime);
Done
```

The broker task acts like a placeholder of sched_entity in the scheduler. The broker task can be registered through the virtual MSR mechanism explained above. The entire registration process will include the following steps:

VMM identifies sibling VMs' vCPU threads that need to be scheduled by the primary VM on the hypervisor and records their tids.

Then the corresponding task is also taken over by the user space scheduling framework described later and falls into sleep through the synchronization lock mechanism.

Subsequently, VMM emulates the RDMSR and WRMSR of VIRT_PARA_SCHED_TASK MSR from the primary VM and informs the primary VM of the tid of the registered sibling VMs' vCPU threads.

The primary VM creates corresponding broker tasks for these sibling VMs' vCPU threads based on the hypervisor tid information obtained from VIRT_PARA_SCHED_TASK MSR.

Finally, the primary VM writes the tid of the broker task and the tid of the corresponding vCPU threads to VIRT_PARA_SCHED_MAP MSR. When the VMM on the hypervisor handles the VM-EXIT caused by the WRMSR of VIRT_PARA_SCHED_MAP MSR, it will obtain this mapping information, so that the corresponding relationship between the broker tasks and the vCPU threads is finally established in the VMM.

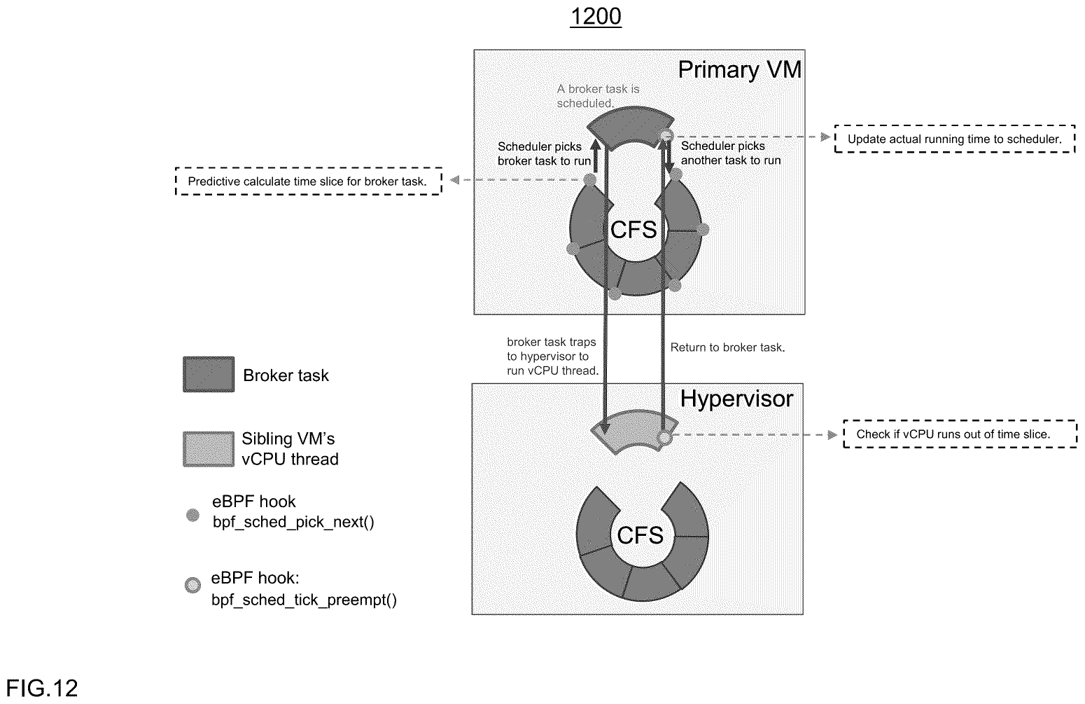

More details and optional aspects of FIG. 11 may be described in connection with examples described above (e.g., FIG. 1 to 10) or below (e.g., FIGS. 12 to 18).

FIG. 12 shows an example 1200 of eBPF hooks of para-virtualized scheduling. eBPF is a revolutionary technology with origins in the Linux kernel that can run sandboxed programs in an operating system kernel. It is used to extend the capabilities of the kernel safely and efficiently without changing kernel source code or load kernel modules. Moreover, the eBPF hooks described require very few changes to the kernel. The eBPF program is user-defined and does not belong to the Linux kernel, so the modification to the kernel code is limited to adding new eBPF hooks. Then, a customized eBPF program can be attached to the corresponding hook through the existing interface of the kernel, to realize the capture of the information in the kernel and the intervention of the kernel behavior.

Another embodiment of the method may comprise a hypervisor providing a cumulative run time of the sibling task to the primary VM.

Therefore, using eBPF hooks to slightly modify the kernel can meet two requirements: to minimize invasive modifications of the Linux kernel and to meet the requirements for flexibility in porting to different environments.

The method may comprise obtaining 275 a cumulative run time of the sibling task and notifying the hypervisor to preempt the sibling task when the cumulative run time exceeds the predictive time slice.

eBPF-driven scheduling may be implemented by inserting eBPF hooks at key scheduling locations. In FIG. 12, there are 3 places for the eBPF hooks:

The first is in the hypervisor's scheduler. This is the place where the scheduler checks whether to switch to another task. Here the scheduler will count the real run time of the current task. And eBPF-driven scheduling needs to expose this run time information to Guest by eBPF hook.

The second is in the Guest (primary VM)'s scheduler. This is the place where the scheduler decides how long the next “broker” task should run. Here the scheduler will calculate the time slice of the next task and this time slice is the core scheduling policy. Since the “broker” task doesn't run in Guest, the Guest needs to expose this scheduling decision by eBPF Hook.

The third is in the place where the scheduler checks whether to switch to another task. Here the scheduler will count the real run time of the current task. And since the “broker” task runs at the hypervisor, the Guest scheduler needs to know this information by eBPF hook.

As an example to explain the eBPF-driven scheduling, these 2 hooks: bpf_sched_pick_next( ) and bpf_sched_tick_preempt( ) could be added.

FIG. 12 shows an example of eBPF hooks of para-virtualized scheduling
(based the example hooks: bpf_sched_pick_next( ) and bpf_sched_tick_preempto).

As an example, with these two eBPF hooks, custom logic may be integrated into the eBPF program attached by the hook, as follows:
bpf_sched_pick_next( ) in primary VM scheduler: predict the time slice based on the information provided by the hook.
bpf_sched_tick_preempt( ) in hypervisor scheduler: check whether the current task is running long enough according to the time slice passed by the primary VM to the hypervisor.
bpf_sched_tick_preempt( ) in primary VM scheduler: check whether the broker task needs to be scheduled out according to the actual running time (this is the steal time per task) of the sibling VMs′ vCPU threads on the hypervisor.

The eBPF hook bpf_sched_pick_next( ) may be added to the scheduler of the primary VM. When the scheduler picks a new task to run next, this hook will be called. In primary VM, an eBPF program attached to this hook is used to detect the broker tasks by their tids. When a broker task is picked by the scheduler to run next, the eBPF program will use the nice value of this broker task and other run queue information to calculate the time slice for this broker task. Then the broker task can access its time slice stored in the eBPF program and write its time slice into VIRT_PARA_SCHED_CTRL MSR.

On the hypervisor, the eBPF hook bpf_sched_tick_preempt( ) is added to the tick interrupt handler of the scheduler. Whenever a tick arrives and the scheduler checks if the currently running task should be switched away, this hook will be called.

In the eBPF program of this hook, these checks may be done:

Check whether the current task is registered to be scheduled by the primary VM.

If so, then check whether the cumulative running time of the current task exceeds the preset virtual time slice. Here virtual time slice is calculated by the primary VM and got from some virtual MSR (e.g., VIRT PARA SCHED CTRL MSR).

If it exceeds, it is determined that the current task should not continue to run and should sleep (The sleeping operation is performed through the scheduling framework on the user space that will be explained below “Worker-Server Scheduling Framework Integrated in vCPU Implementation”).

With this hook and the eBPF program attached to it, the occupation of physical CPU resources by sibling VMs′ vCPU threads on the hypervisor will be controlled and limited by the primary VM, through the “virtual time slice” calculated by the primary VM.

In the primary VM, because the running time of the broker task is stolen by the mapped sibling VMs' vCPU threads, the scheduler of the primary VM needs to use the steal time information (that will be explained below “Per Task Steal Time Hints in Primary VM's Scheduler”), which is provided by eBPF program attached on this hook, to check if current broker task should be preempted.

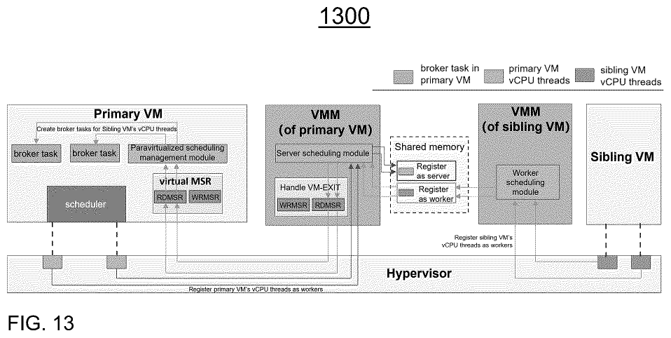

More details and optional aspects of FIG. 12 may be described in connection with examples described above (e.g., FIG. 1 to 11) or below (e.g., FIGS. 13 to 18).

FIG. 13 shows an example 1300 registration of a worker and server. As shown in FIG. 13, the server VM will create a piece of shared memory, and the workers, which are sibling VMs′ vCPU threads, will access this shared memory and register themselves in the server's run queue. Then the workers will sleep through FUTEX_WAIT until the server wakes them up to run through FUTEX_WAKE.

Primary VM provides scheduling hints but does not schedule sibling VMs' vCPU threads directly. On the hypervisor, the real scheduling under the influence of these hints depends on the scheduling framework of the user space, this is “Worker-Server Scheduling Framework Integrated in vCPU Implementation”.

The core design of this scheduling framework includes the following points:

Here there are two scheduling roles: server task and worker task. Each server has its own run queue of workers and controls the sleep and wake-up of its workers. Primary VM's vCPU threads are registered as servers. Each worker will be added to a server's run queue. All sibling VMs′ vCPU threads on a hypervisor that need to be scheduled by the primary VM are registered as workers.

This framework is based on the futex synchronization mechanism of the Linux kernel and uses FUTEX_WAIT and FUTEX_WAKE to implement task sleep and wakeup.

With the para-virtualized scheduling feature enabled, the vCPU threads of the primary VM can be created as the servers. When the server finds that there's a worker available in its run queue, it will pass the workers′ tids to the primary VM via some virtual MSR (e.g., VIRT PARA SCHED TASK MSR).

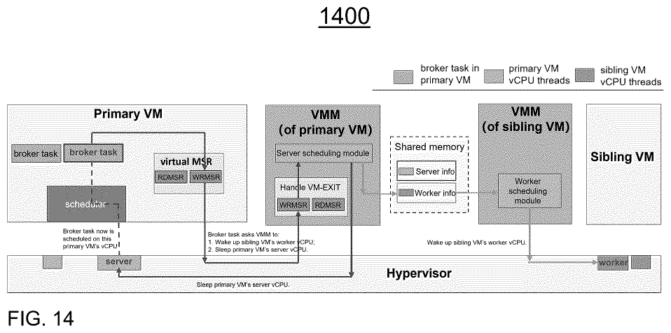

More details and optional aspects of FIG. 13 may be described in connection with examples described above (e.g., FIG. 1 to 12) or below (e.g., FIGS. 14 to 18).

FIG. 14 shows waking up the worker and sleeping the server in accordance with one example 1400. After registration, only servers are running and in the meanwhile, all workers are sleeping.

In FIG. 14, when a broker task is scheduled by the scheduler of the primary VM, this broker task writes the time slice to some virtual MSR (e.g., VIRT_PARA_SCHED_CTRL) to trigger VM-EXIT.

When the VMM receives this VM-EXIT event and the time slice information, it knows it's time to wake up the worker mapped to this broker task. At the same time, the server running the broker task, i.e., the vCPU thread of the primary VM, must be put to sleep.

In addition, the VMM will also store this time slice in the eBPF program of the added eBPF hook (e.g., bpf_sched_tick_preempt( )). This eBPF hook with its eBPF program will monitor the execution time of the worker.

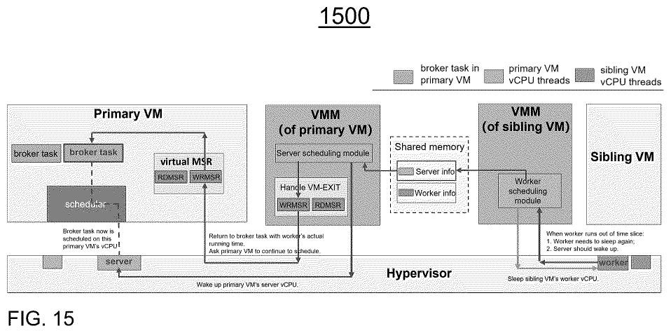

More details and optional aspects of FIG. 14 may be described in connection with examples described above (e.g., FIG. 1 to 13) or below (e.g., FIGS. 15 to 18).

FIG. 15 shows waking up the server and sleeping the worker in accordance with one example 1500. When the cumulative run time of the worker has exceeded the time slice stored in the eBPF program, this eBPF program will notify the worker's VMM to put the worker to sleep and wake up the server corresponding to that worker, as shown in FIG. 15.

Finally, when the server wakes up, the VMM of the primary VM tells the primary VM the cumulative run time of the previous worker through some virtual MSR (e.g., VIRT_PARA_SCHED_CTRL).

At this point, the primary VM has completed scheduling a sibling VM's vCPU thread.

In the primary VM, the time of the broker task is stolen by the worker on the hypervisor. Therefore, the concept of per-task steal time may be useful. This per-task steal time calculates the time stolen from a broker task by the corresponding sibling VM's vCPU thread on the hypervisor, and this steal time information is “Per Task Steal Time Hints in Primary VM's Scheduler”.

The broker task does nothing but try to trap, and the real work is passed from the broker task to the corresponding sibling VM's vCPU thread on the hypervisor, i.e., the worker, to perform. Therefore, the worker inherits the time slice from the broker task and consumes that time slice on the hypervisor instead of the broker task. After the time slice is consumed, the worker returns control to the broker task.

To ensure that the broker task can be scheduled normally by the scheduler, in the primary VM the eBPF hook (e.g., bpf_sched_tick_preempto) may be used and its eBPF program to deliver the broker task's steal time to the scheduler.

The entire process of obtaining and using steal time may comprise: First, actively injecting a timer interrupt into the server before the server's VM-ENTRY. This should trigger the server's scheduling preemption check. Second, in the primary VM, the broker task obtains the cumulative running time read from a virtual MSR (e.g., VIRT_PARA_SCHED_CTRL) and communicates this cumulative running time to eBPF program of the added eBPF hook (e.g., bpf_sched_tick_preempto) in primary VM's kernel. Third, the primary VM's scheduler will decide whether to preempt the current broker task by considering the cumulative running time in the added eBPF hook (e.g., bpf_sched_tick_preempto).

It should be noted that the definition of virtual MSRs and eBPF hooks in the actual implementation may differ from the examples disclosed herein, but the essential steps may be the same.

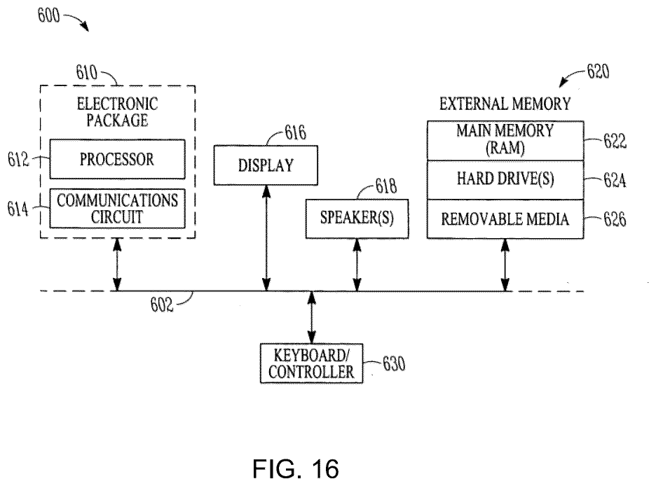

More details and optional aspects of FIG. 15 may be described in connection with examples described above (e.g., FIG. 1 to 14) or below (e.g., FIGS. 16 to 18).

FIG. 16 is a block diagram of an electronic apparatus incorporating at least one electronic assembly and/or method described herein.

Electronic apparatus 600 is merely one example of an electronic apparatus in which forms of the electronic assemblies and/or methods described herein may be used. Examples of an electronic apparatus 600 include but are not limited to, personal computers, tablet computers, mobile telephones, game devices, MP3 or other digital music players, etc. In this example, electronic apparatus 600 comprises a data processing system that includes a system bus 602 to couple the various components of the electronic apparatus 600. System bus 602 provides communications links among the various components of the electronic apparatus 600 and may be implemented as a single bus, as a combination of busses, or in any other suitable manner.

An electronic assembly 610 as described herein may be coupled to system bus 602. The electronic assembly 610 may include any circuit or combination of circuits. In one embodiment, the electronic assembly 610 includes a processor 612 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 610 are a custom circuit, an application-specific integrated circuit (ASIC), or the like, such as, for example, one or more circuits (such as a communications circuit 614) for use in wireless devices like mobile telephones, tablet computers, laptop computers, two-way radios, and similar electronic systems. The IC can perform any other type of function.

The electronic apparatus 600 may also include an external memory 620, which in turn may include one or more memory elements suitable to the particular application, such as a main memory 622 in the form of random access memory (RAM), one or more hard drives 624, and/or one or more drives that handle removable media 626 such as compact disks (CD), flash memory cards, digital video disk (DVD), and the like.

The electronic apparatus 600 may also include a display device 616, one or more speakers 618, and a keyboard and/or controller 630, which can include a mouse, trackball, touch screen, voice-recognition device, or any other device that permits a system user to input information into and receive information from the electronic apparatus 600.

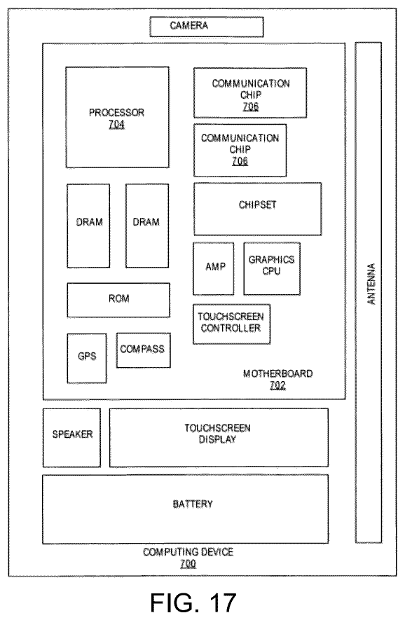

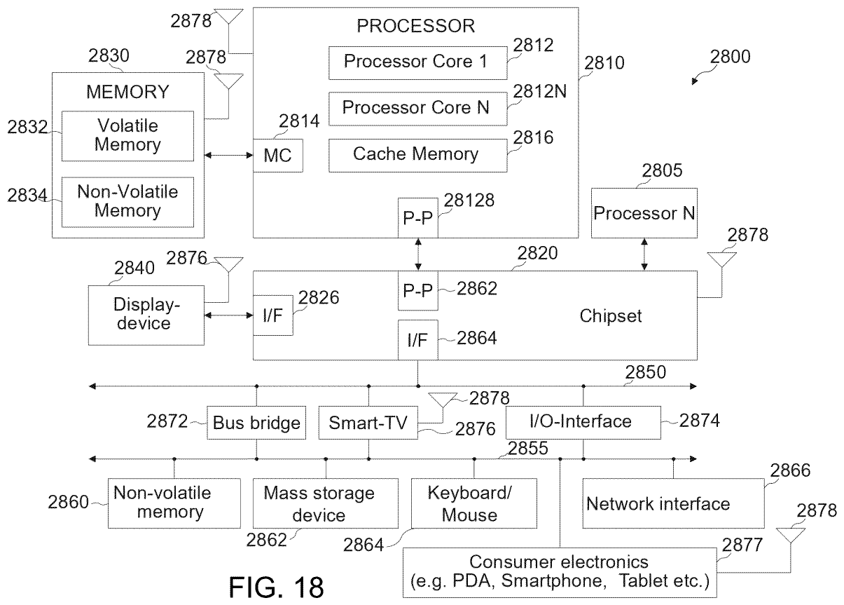

More details and optional aspects of FIG. 16 may be described in connection with examples described above (e.g., FIG. 1 to 15) or below (e.g., FIGS. 17 to 18).

FIG. 17 illustrates a computing device in accordance with one implementation of the disclosed embodiments. The computing device 700 houses a board 702. The board 702 may include a number of components, including but not limited to a processor 704 and at least one communication chip 706. The processor 704 is physically and electrically coupled to the board 702. In some implementations, the at least one communication chip 706 is also physically and electrically coupled to the board 702. In further implementations, the communication chip 706 is part of the processor 704. Depending on its applications, computing device 700 may include other components that may or may not be physically and electrically coupled to the board 702. These other components include, but are not limited to, volatile memory (e.g., DRAM), non-volatile memory (e.g., ROM), flash memory, a graphics processor, a digital signal processor, a cryptoprocessor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter-range wireless communications such as Wi-Fi and Bluetooth and a second communication chip 706 may be dedicated to longer-range wireless communications such as GPS, EDGE, GPRS, CDMA, WiMAX, LTE, Ev-DO, and others. The processor 704 of the computing device 700 includes an integrated circuit die packaged within the processor 704. In some implementations of the disclosed embodiments, the integrated circuit die of the processor includes one or more devices that are assembled in an ePLB or eWLB-based POP package that includes a mold layer directly contacting a substrate, in accordance with implementations of the disclosed embodiments. The term “processor” may refer to any device or portion of a device that processes electronic data from registers and/or memory to transform that electronic data into other electronic data that may be stored in registers and/or memory. The communication chip 706 also includes an integrated circuit die packaged within the communication chip 706. In accordance with another implementation of the disclosed embodiments, the integrated circuit die of the communication chip includes one or more devices that are assembled in an ePLB or eWLB-based POP package that includes a mold layer directly contacting a substrate, in accordance with implementations of the disclosed embodiments.

More details and optional aspects of FIG. 17 may be described in connection with examples described above (e.g., FIG. 1 to 16) or below (e.g., FIG. 18).

FIG. 18 shows an example of a higher-level device application for the disclosed embodiments. The MAA cantilevered heat pipe apparatus embodiments may be found in several parts of a computing system. In an embodiment, the MAA cantilevered heat pipe is part of a communications apparatus such as is affixed to a cellular communications tower. The MAA cantilevered heat pipe may also be referred to as an MAA apparatus. In an embodiment, a computing system 2800 includes but is not limited to, a desktop computer. In an embodiment, a system 2800 includes, but is not limited to a laptop computer. In an embodiment, a system 2800 includes, but is not limited to a netbook. In an embodiment, a system 2800 includes, but is not limited to a tablet. In an embodiment, a system 2800 includes, but is not limited to a notebook computer. In an embodiment, a system 2800 includes, but is not limited to a personal digital assistant (PDA). In an embodiment, a system 2800 includes, but is not limited to a server.

In an embodiment, a system 2800 includes, but is not limited to a workstation. In an embodiment, a system 2800 includes, but is not limited to a cellular telephone. In an embodiment, a system 2800 includes, but is not limited to a mobile computing device. In an embodiment, a system 2800 includes, but is not limited to a smartphone. In an embodiment, a system 2800 includes, but is not limited to an internet appliance. Other types of computing devices may be configured with the microelectronic device that includes MAA apparatus embodiments.

In an embodiment, the processor 2810 has one or more processing cores 2812 and 2812N, where 2812N represents the Nth processor core inside processor 2810 where N is a positive integer. In an embodiment, the electronic device system 2800 uses an MAA apparatus embodiment that includes multiple processors including 2810 and 2805, where the processor 2805 has logic similar or identical to the logic of the processor 2810. In an embodiment, the processing core 2812 includes but is not limited to, pre-fetch logic to fetch instructions, decode logic to decode the instructions, execution logic to execute instructions, and the like. In an embodiment, the processor 2810 has a cache memory 2816 to cache at least one of instructions and data for the MAA apparatus in the system 2800. The cache memory 2816 may be organized into a hierarchal structure including one or more levels of cache memory.

In an embodiment, the processor 2810 includes a memory controller 2814, which is operable to perform functions that enable the processor 2810 to access and communicate with memory 2830 which includes at least one of a volatile memory 2832 and a non-volatile memory 2834. In an embodiment, the processor 2810 is coupled with memory 2830 and chipset 2820. The processor 2810 may also be coupled to a wireless antenna 2878 to communicate with any device configured to at least one of transmit and receive wireless signals. In an embodiment, the wireless antenna interface 2878 operates in accordance with but is not limited to, the IEEE 802.11 standard and its related family, Home Plug AV (HPAV), Ultra Wide Band (UWB), Bluetooth, WiMax, or any form of wireless communication protocol.

In an embodiment, the volatile memory 2832 includes but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2834 includes but is not limited to, flash memory, phase change memory (PCM), read-only memory (ROM), electrically erasable programmable read-only memory (EEPROM), or any other type of non-volatile memory device.

The memory 2830 stores information and instructions to be executed by the processor 2810. In an embodiment, the memory 2830 may also store temporary variables or other intermediate information while the processor 2810 is executing instructions. In the illustrated embodiment, the chipset 2820 connects with processor 2810 via Point-to-Point (PtP or P-P) interfaces 2817 and 2822. Either of these PtP embodiments may be achieved using an MAA apparatus embodiment as set forth in this disclosure. The chipset 2820 enables the processor 2810 to connect to other elements in the MAA apparatus embodiments in a system 2800. In an embodiment, interfaces 2817 and 2822 operate in accordance with a PtP communication protocol such as the QuickPath Interconnect (QPI) or the like. In other embodiments, a different interconnect may be used.

In an embodiment, the chipset 2820 is operable to communicate with the processor 2810, 2805N, the display device 2840, and other devices 2872, 2876, 2874, 2860, 2862, 2864, 2866, 2877, etc. The chipset 2820 may also be coupled to a wireless antenna 2878 to communicate with any device configured to at least one of transmit and receive wireless signals.

The chipset 2820 connects to the display device 2840 via the interface 2826. The display 2840 may be, for example, a liquid crystal display (LCD), a plasma display, a cathode ray tube (CRT) display, or any other form of visual display device. In an embodiment, the processor 2810 and the chipset 2820 are merged into an MAA apparatus in a system. Additionally, the chipset 2820 connects to one or more buses 2850 and 2855 that interconnect various elements 2874, 2860, 2862, 2864, and 2866. Buses 2850 and 2855 may be interconnected together via a bus bridge 2872 such as at least one MAA apparatus embodiment. In an embodiment, the chipset 2820 couples with a non-volatile memory 2860, a mass storage device(s) 2862, a keyboard/mouse 2864, and a network interface 2866 by way of at least one of the interface 2824 and 2874, the smart TV 2876, and the consumer electronics 2877, etc.

In an embodiment, the mass storage device 2862 includes but is not limited to, a solid-state drive, a hard disk drive, a universal serial bus flash memory drive, or any other form of computer data storage medium. In one embodiment, the network interface 2866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with but is not limited to, the IEEE 802.11 standard and its related family, Home Plug AV (HPAV), Ultra-Wide Band (UWB), Bluetooth, WiMax, or any form of wireless communication protocol.

While the modules shown in FIG. 18 are depicted as separate blocks within the MAA apparatus embodiment in a computing system 2800, the functions performed by some of these blocks may be integrated within a single semiconductor circuit or may be implemented using two or more separate integrated circuits. For example, although cache memory 2816 is depicted as a separate block within processor 2810, cache memory 2816 (or selected aspects of 2816) can be incorporated into the processor core 2812.

Where useful, the computing system 2800 may have a broadcasting structure interface such as for affixing the MAA apparatus to a cellular tower.

More details and optional aspects of FIG. 18 may be described in connection with examples described above (e.g., FIG. 1 to 17) or below.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some examples, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B, or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B, and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations, or processes of various above-described methods may be performed by programmed computers or processors. Examples may also cover program storage devices such as digital data storage media, which are machine, processor, or computer-readable and encode machine-executable, processor-executable, or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors, or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application-specific integrated circuit (ASIC), field programmable gate array (FPGA), read-only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations, or steps, which may, for instance, be substantially represented in a computer-readable medium and so executed by a computer or processor, whether or not such computer or processor is explicitly shown. Methods disclosed in the specification or in the claims may be implemented by a device having means for performing each of the respective acts of these methods.

An example (e.g., example 1) relates to a method for a primary virtual machine (VM) to schedule a task from a sibling VM on a hypervisor. The method comprising: obtaining, from the hypervisor, a hypervisor task identification (ID) for a sibling task, wherein the sibling task originated at the sibling VM; creating a broker task in the primary VM based on the hypervisor task ID, wherein the broker task comprises a broker task ID and wherein the broker task corresponds to the sibling task; communicating a mapping of the broker task ID to the corresponding hypervisor task ID of the sibling task to the hypervisor; executing the broker task in the primary VM when chosen by a primary VM scheduler; and notifying the hypervisor to run the sibling task mapped to the broker task.

Another example (e.g., example 2) relates to a previously described example (e.g., example 1), wherein the sibling task is a virtual thread of the sibling VM.

Another example (e.g., example 3) relates to a previously described example (e.g., examples 1-2), further comprising obtaining workload information on the sibling task from the sibling VM.

Another example (e.g., example 4) relates to a previously described example (e.g., example 3), wherein the primary VM scheduler chooses the broker task to run based on the workload information.

Another example (e.g., example 5) relates to a previously described example (e.g., examples 1-4), further comprising computing a predictive time slice for the broker task and the corresponding sibling task; and communicating the predictive time slice to the hypervisor when the broker task is chosen to run by the primary VM scheduler.

Another example (e.g., example 6) relates to a previously described example (e.g., example 5), wherein the predictive time slice is computed based on timing information obtained from the hypervisor.

Another example (e.g., example 7) relates to a previously described example (e.g., example 6), wherein the timing information comprises a nice value of the broker task and queue information of a hypervisor scheduler.

Another example (e.g., example 8) relates to a previously described example (e.g., examples 5-7), further comprising obtaining a cumulative run time of the sibling task and notifying the hypervisor to preempt the sibling task when the cumulative run time exceeds the predictive time slice.

An example (e.g., example 9) relates to a method for a hypervisor to schedule a plurality of tasks from a primary VM and a sibling VM. The method comprising: creating a sibling task requested by the sibling VM, wherein the sibling task comprises a hypervisor task ID created by the hypervisor; communicating the hypervisor task ID to the primary VM; obtaining a mapping of a broker task to the corresponding hypervisor task ID of the sibling task; and running the sibling task when notified by the primary VM; wherein the broker task triggers the running of the sibling task according to the mapping.

Another example (e.g., example 10) relates to a previously described example (e.g., example 9), wherein the sibling task is a virtual thread of the sibling VM.

Another example (e.g., example 11) relates to a previously described example (e.g., examples 9-10), further comprising providing timing information to the primary VM.

Another example (e.g., example 12) relates to a previously described example (e.g., example 11), wherein the timing information on the sibling task comprises a nice value of the broker task and queue information of a hypervisor scheduler.

Another example (e.g., example 13) relates to a previously described example (e.g., examples 11 or 12), further comprising receiving a predictive time slice for the broker task based on the timing information, wherein the broker task triggers the running of the sibling task according to the predictive time slice.

Another example (e.g., example 14) relates to a previously described example (e.g., examples 9-13), further comprising providing a cumulative run time of the sibling task to the primary VM.

Another example (e.g., example 15) relates to a previously described example (e.g., examples 1-14), wherein the primary VM communicates with the hypervisor via a set of virtual registers.

Another example (e.g., example 16) relates to a previously described example (e.g., example 15), wherein the primary VM both receives the hypervisor ID and provides the mapping via the set of virtual registers.

Another example (e.g., example 17) relates to a previously described example (e.g., examples 15 or 16), wherein the virtual registers are virtual model-specific registers defined by a virtual machine monitor.

Another example (e.g., example 18) relates to a previously described example (e.g., examples 1-17), wherein the primary VM resides on a system further comprising the sibling VM and the hypervisor, and wherein the primary VM administrates the system, controls allocation of the system's resources, and manages the creation and destruction of the sibling VM.

Another example (e.g., example 19) relates to a previously described example (e.g., examples 1-18), wherein the primary VM and the sibling VM are deprivileged.

An example (e.g., example 20) relates to a method for a primary virtual machine (VM) to schedule a task from a sibling VM on a hypervisor. The method comprising: creating, at the hypervisor, a sibling task requested by the sibling VM, wherein the sibling task comprises a hypervisor task ID created by the hypervisor; communicating, from the hypervisor to the primary VM, a hypervisor task identification (ID) for the sibling task; creating, at the primary VM, a broker task based on the hypervisor ID, wherein the broker task comprises a broker task ID and wherein the broker task corresponds to the sibling task; creating, at the hypervisor, the broker task requested by the primary VM; Creating, at the primary VM, a mapping of the broker task to with the corresponding hypervisor task ID of the sibling task; executing the broker task at the primary VM; and executing the sibling task at the hypervisor when notified by the primary VM; wherein sibling task's execution at the hypervisor is triggered by the broker task according to the mapping.

Another example (e.g., example 21) relates to a non-transitory, computer-readable medium comprising a program code that, when the program code is executed on a processor, a computer, or a programmable hardware component, causes the processor, computer, or programmable hardware component to perform the method of a previously described example (e.g., examples 1-20).

Another example (e.g. example 22) relates to a system comprising the processor and the non-transitory, computer-readable medium of a previously described example (e.g., example 21).

Another example (e.g., example 23) relates to a previously described example (e.g., example 22), wherein the primary VM administrates the system, allocates resources of the system, and creates and destroys the sibling VM.

An example (e.g., example 24) relates to a method for a primary virtual machine (VM) to schedule a task from a sibling VM on a hypervisor. The method comprising: obtaining, from the hypervisor, a hypervisor task identification (ID) for a sibling task, wherein the sibling task originated at the sibling VM; creating a broker task in the primary VM based on the hypervisor task ID, wherein the broker task comprises a broker task ID and wherein the broker task corresponds to the sibling task; communicating a mapping of the broker task ID to the corresponding hypervisor task ID of the sibling task to the hypervisor; and notifying the hypervisor to run the sibling task when chosen by a primary VM scheduler.

An example (e.g., example 25) relates to a method for a hypervisor to schedule a plurality of tasks from a primary VM and a sibling VM. The method comprising: creating a sibling task requested by the sibling VM, wherein the sibling task comprises a hypervisor task ID created by the hypervisor; communicating the hypervisor task ID to the primary VM; creating a broker task requested by the primary VM, wherein the broker task corresponds to the sibling task, and wherein the broker task comprises a broker task ID created by the primary VM; obtaining a mapping of the broker task ID to the corresponding hypervisor task ID of the sibling task; and executing the broker task when notified by the primary VM; wherein the broker task triggers the running of the sibling task according to the mapping.

An example (e.g., example 26) relates to a method for a primary virtual machine (VM) to schedule a task from a sibling VM on a hypervisor. The method comprising: creating, at the hypervisor, a sibling task requested by the sibling VM, wherein the sibling task comprises a hypervisor task ID created by the hypervisor; communicating, from the hypervisor to the primary VM, a hypervisor task identification (ID) for the sibling task; creating, at the primary VM, a broker task based on the hypervisor ID, wherein the broker task comprises a broker task ID and wherein the broker task corresponds to the sibling task; creating, at the hypervisor, the broker task requested by the primary VM; communicating, from the primary VM to the hypervisor, a mapping of the broker task to with the corresponding hypervisor task ID of the sibling task; and executing the broker task at the hypervisor when notified by the primary VM; wherein the broker task triggers the running of the sibling task at the hypervisor according to the mapping.

An example (e.g. example 27) relates to a non-transitory, computer-readable medium comprising a program code that, when the program code is executed on a processor, a computer, or a programmable hardware component, causes the processor, the computer, or the programmable hardware component to perform the method of a previously described example (e.g. one of the examples 1-26).

An example (e.g. example 28) is a system comprising an apparatus, computer-readable medium, or circuitry for performing a method of a previously described example (e.g. one of the examples 1-27).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example, as well as other non-transitory computer readable mediums. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes, or -operations.

If some aspects have been described in relation to a device or system, these aspects should also be understood as a description of the corresponding method. For example, a block, device, or functional aspect of the device or system may correspond to a feature, such as a method step, of the corresponding method. Accordingly, aspects described in relation to a method shall also be understood as a description of a corresponding block, a corresponding element, a property, or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect, feature, or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation. The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed unless it is stated in the individual case that a particular combination is not intended. Furthermore, features of a claim should also be included for any other independent claim, even if that claim is not directly defined as dependent on that other independent claim.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent on the independent claim.

What is claimed is:

1. A non-transitory, computer-readable medium comprising a program code that, when the program code is executed on a processor, a computer, or a programmable hardware component, causes the processor, computer, or programmable hardware component to perform a method for a primary virtual machine (VM) to schedule a task from a sibling VM on a hypervisor, the method comprising:
obtaining, from the hypervisor, a hypervisor task identification (ID) for a sibling task, wherein the sibling task originated at the sibling VM;
creating a broker task in the primary VM based on the hypervisor task ID, wherein the broker task comprises a broker task ID and wherein the broker task corresponds to the sibling task;
communicating a mapping of the broker task ID to the corresponding hypervisor task ID of the sibling task to the hypervisor;
executing the broker task when chosen by a primary VM scheduler; and
notifying the hypervisor to execute the sibling task mapped to the broker task.

2. The computer-readable medium of claim 1, wherein the sibling task is a virtual thread of the sibling VM.

3. The computer-readable medium of claim 1, further comprising obtaining workload information on the sibling task from the sibling VM.

4. The computer-readable medium of claim 3, wherein the primary VM scheduler chooses the broker task to run based on the workload information.

5. The computer-readable medium of claim 1, further comprising computing a predictive time slice for the broker task and the corresponding sibling task; and
communicating the predictive time slice to the hypervisor when the broker task is chosen to run by the primary VM scheduler.

6. The computer-readable medium of claim 5, wherein the predictive time slice is computed based on timing information obtained from the hypervisor.

7. The computer-readable medium of claim 6, wherein the timing information comprises a nice value of the broker task and queue information of a hypervisor scheduler.

8. The computer-readable medium of claim 5, further comprising obtaining a cumulative run time of the sibling task and notifying the hypervisor to preempt the sibling task when the cumulative run time exceeds the predictive time slice.

9. The computer-readable medium of claim 1, wherein the primary VM communicates with the hypervisor via a set of virtual registers.

10. The computer-readable medium of claim 1, wherein the primary VM resides on a system further comprising the sibling VM and the hypervisor, and wherein the primary VM administrates the system, controls an allocation of the system's resources, and manages the creation and destruction of the sibling VM.

11. The computer-readable medium of claim 1, wherein the primary VM communicates with the hypervisor via a set of virtual registers.

12. A non-transitory, computer-readable medium comprising a program code that, when the program code is executed on a processor, a computer, or a programmable hardware component, causes the processor, computer, or programmable hardware component to perform a method for a hypervisor to schedule a plurality of tasks from a primary VM and a sibling VM, the method comprising:
creating a sibling task requested by the sibling VM, wherein the sibling task comprises a hypervisor task ID created by the hypervisor;
communicating the hypervisor task ID to the primary VM;
obtaining a mapping of a broker task to the corresponding hypervisor task ID of the sibling task; and
executing a sibling task when notified by the primary VM, wherein the broker task triggers the running of the sibling task according to the mapping.

13. The computer-readable medium of claim 12, wherein the sibling task is a virtual thread of the sibling VM.

14. The computer-readable medium of claim 12, further comprising providing timing information to the primary VM.

15. The computer-readable medium of claim 14, wherein the timing information on the sibling task comprises a nice value of the broker task and queue information of a hypervisor scheduler.

16. The computer-readable medium of claim 14, further comprising receiving a predictive time slice for the broker task based on the timing information, wherein the broker task triggers the running of the sibling task according to the predictive time slice.

17. The computer-readable medium of claim 12, further comprising providing a cumulative run time of the sibling task to the primary VM.

18. The computer-readable medium of claim 12, wherein the primary VM both receives the hypervisor ID and provides the mapping via the set of virtual registers.

19. A non-transitory, computer-readable medium comprising a program code that, when the program code is executed on a processor, a computer, or a programmable hardware component, causes the processor, computer, or programmable hardware component to perform a method for a primary virtual machine (VM) to schedule a task from a sibling VM on a hypervisor, the method comprising:
creating, at the hypervisor, a sibling task requested by the sibling VM, wherein the sibling task comprises a hypervisor task ID created by the hypervisor;
communicating, from the hypervisor to the primary VM, a hypervisor task identification (ID) for the sibling task;
creating, at the primary VM, a broker task based on the hypervisor ID, wherein the broker task comprises a broker task ID and wherein the broker task corresponds to the sibling task;
creating at the primary VM, a mapping of the broker task to with the corresponding hypervisor task ID of the sibling task;
executing the broker task at the primary VM; and
executing the sibling task at the hypervisor when notified by the primary VM;
wherein the sibling task's execution at the hypervisor is triggered by the broker task according to the mapping.

20. A system comprising the processor and the non-transitory, computer-readable medium of claim 19, wherein the primary VM administrates the system, allocates resources of the system, and creates and destroys the sibling VM.
